(19) United States
(12) Patent Application Publication
(10) Pub. No.: US 2006/0199426 A1
(43) Pub. Date: Sep. 7, 2006

(54) Carrying assembly

(76) Inventors: Charles Williams, (US); Lawrence Stotts, (US)

Correspondence Address: RICHARD O. CHURCH, 19 WESTVIEW TERRACE, WOMELSDORF, PA, 19567, US

(21) Appl. No.: 11/273,975

(22) Filed: Nov. 15, 2005

Related U.S. Application Data
(60) Provisional application No. 60/628,892, filed on Nov. 18, 2004.

(51) Int. Cl. H01R 11/00

(52) U.S. Cl. 439/502

(57) ABSTRACT

A carrying case for small items like cell telephones is easily attached to a person's belt or other object such as an automobile dashboard. The carrying case and the attachment means utilize a male and a female element that are easily engaged in seating relationship with each other. When engaged, the elements may be secured to each other by means of a moveable bifurcated plate that can be slid into engagement with a groove on the male element.

### HISTORY OF THE APPLICATION

This application is based upon and claims priority from U.S. Provisional Patent Application Ser. No. 60/628,892 filed on Nov. 18, 2004.

### BACKGROUND OF THE INVENTION

The invention relates to an assembly for carrying small items, such as cell telephones, pagers and the like on one's person. More particularly, the invention relates to a cooperative combination of a male and a female fixture, one of which is attached as to a person's belt and the other of which is attached to a small item or its protective case. The invention provides means by which the male and female fixtures can be rotated relative to each other, means by which the fixtures can easily be engaged or disengaged from each other, and means that serve to protect the fixtures from damage.

A number of carrying assemblies are disclosed in the prior art which utilize male and female fixtures that can be secured to each other and released from engagement as desired. Most often, one of the fixtures is attached to a person's belt and the other fixture is secured to a small personal item or its carrying case. By way of example, reference is made to U.S. Pat. No. 4,605,335 in which a male fixture in the form of a shaped button is received in a like shaped opening in a female fixture. The male fixture is attached to the personal item and the female fixture is attached to a person's belt. In this assembly, the button is inserted axially into an opening in the female fixture much like a key is inserted into a lock. The button is then rotated in to a locked position to secure the male fixture within the female fixture. The procedure can be reversed to separate the fixtures.

Other types of carrying assemblies utilize arrangements in which the female fixture is generally “U” shaped with the free end extending upward. This permits the male fixture to be inserted into the opening in the female fixture. One such arrangement of this sort is disclosed in U.S. Pat. No. 3,878,589. The design of this apparatus, as does the '335 patent, requires that the male fixture be correctly oriented with respect to the female fixture to engage or disengage one from the other.

An improved design is disclosed in U.S. Pat. No. 5,054,170 that makes it easier to engage the male fixture with the female fixture. In this instance, the male fixture can be inserted in the female fixture without regard to their relative orientation. But, to avoid accidental separation of one from the other, the male fixture must be rotated into a predetermined position with respect to the female fixture to permit separation of the two fixtures. Other devices, rather than relying on the orientation of the fixtures, make use of latch mechanisms that secure the male fixture within and release it from the female fixture.

In summary, the prior art discloses many carrying assemblies in which a first fixture is attached to one's person, as by a belt or strap, and a second fixture that mates with the first fixture is attached to the device or a case in which it is carried. The first and second fixtures are ordinarily male and female fixtures that can be positioned relative to each other to enable the fixtures to be engaged with or disengaged from each other. Achieving an alignment required to engage or disengage the fixtures may prove to be awkward if not formidable, considering that the carrying assembly most commonly is held in a position which may be difficult to see. It is also true that some of the assemblies of the prior art are poorly designed to protect them from abuse and damage.

### SUMMARY OF THE INVENTION

Accordingly, it is an object of this invention to provide an assembly in which a personal item, or its carrying case, is held in an assembly when the personal item is not in use.

Another object of the invention is to provide an assembly in which a personal item, or its carrying case, can be safely secured.

Another object of the invention is to provide a carrying assembly comprising a male and female fixture which can be engaged or disengaged from each other with a minimum of inconvenience.

Another object of the invention is to provide a carrying assembly comprising a male and female fixture which may be engaged with or disengaged from each other without aligning the fixtures in any particular orientation one to another.

Yet a further object of this invention is to provide a carrying assembly which is designed to protect it from inadvertent damage or destruction.

These and other objects are achieved by providing a male fixture that can be secured in and released from a female fixture. The female fixture has an upwardly directed, generally “U” shaped opening to accommodate and seat the male fixture. The male fixture, which is a cylindrical, grooved stud, is secured within the female fixture by a planar, essentially rectangular locking plate which is mounted in sliding relationship to the female fixture. The locking plate is provided with a yoke that seats around the circumferential groove of a male fixture to prevent axial movement of the male fixture and maintain the fixtures secured to each other. When desired, the fixtures may be detached from each other by sliding the yoke of the locking plate out of the circumferential groove. Because the locking plate “locks” with the yoke in the circumferential groove of the male fixture, the female fixture can be rotated through a full arc of 360° relative to the male fixture.

### BRIEF DESCRIPTION OF THE DRAWINGS

A preferred assembly of the invention is shown in the drawings in which:

FIG. 1 is a perspective view of a cradle adapted to receive and hold a wireless telephone;

FIG. 2 is a plan view of the back side of the cradle of FIG. 1;

FIG. 3 is a plan view in front elevation of a female fixture of the invention;

FIG. 4 is a sectional view taken along line 4-4 of FIG. 3;

FIG. 5 is a plan view in front elevation of a locking plate useful in the practice of the invention;

FIG. 6 is a plan view in side elevation of the locking plate of FIG. 5;

FIG. 7 is a plan view in side elevation of the male fixture of the invention; and

FIG. 8 is a sectional view, partially cut away, taken along line 8-8 of FIG. 3 as it would appear if the locking plate of FIGS. 5 and 6 and the male fixture of FIG. 7 were associated in a locked position relative to each other.

### DETAILED DESCRIPTION OF THE DRAWINGS

The same reference numerals are used throughout to identify the same elements as shown on the several drawings.

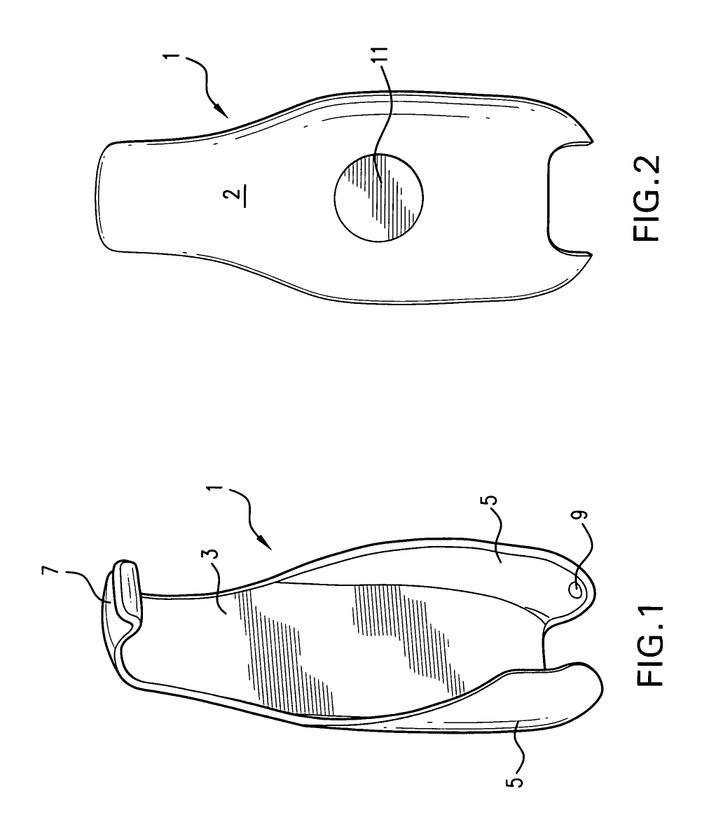

FIGS. 1 and 2 illustrate a cradle 1 configured to accommodate a cell telephone. It is made from resilient material, perhaps of metal or plastic that is shaped to receive and hold a cell telephone or other small device. The cradle 1 has a body portion 3 and sides members 5-5 shaped to conform to the contour of a cell telephone. The cradle one has a top latching member 7 designed to snap over the top of a cell telephone. A detent 9 is positioned at the bottom of the cradle 1 to retain the bottom of a cell telephone.

FIG. 2 shows the back side 2 of the holder 1. A male member 11 is secured to and extends perpendicularly from the back of the holder 1.

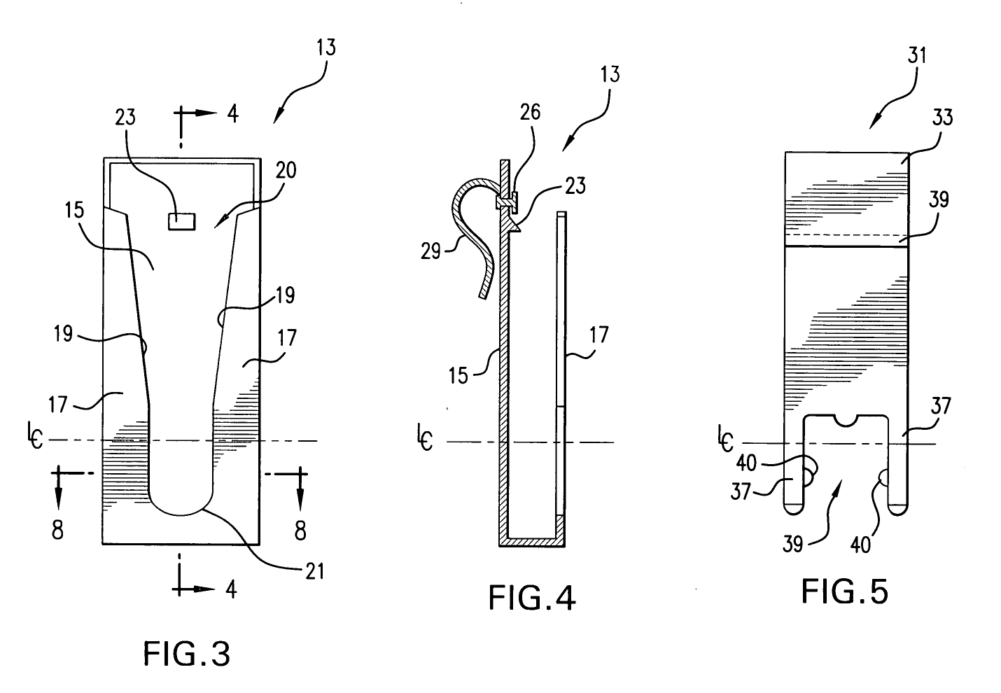

FIG. 3 is a view of the front of a female fixture 13 that is useful in the practice of the invention. The female fixture 13 comprises two parallel, spaced apart flat panels 15 and 17. The back panel 15 is shown as a rectilinear solid piece of material. The front panel 17 has a central cut out portion 20 defined by the side walls 19-19 and bottom wall 21. The side walls 19-19 of cut out portion 20 of the front plate 17 are sloped downwardly and inwardly to progressively narrow the width of the cut out portion 20 that terminate at the arcuate wall 21. An inwardly directed detent 23 is formed on the back panel 15.

The female fixture 13 is designed to include an attachment means 29 secured by a fastener 26. As illustrated in FIG. 4 the attachment means 29 is a spring fastener which may be useful, for example, for attaching the female fixture 13 to a belt or other article of clothing. The nature of the attachment means 29 is of no particular consequence and could be, for example, a Velcro® fastener, a clamshell like spring clip, etc., etc. It is also noted that the female fixture does not have to be attached to clothing but most any substrate such as, for example, the dashboard of an automobile would be appropriate.

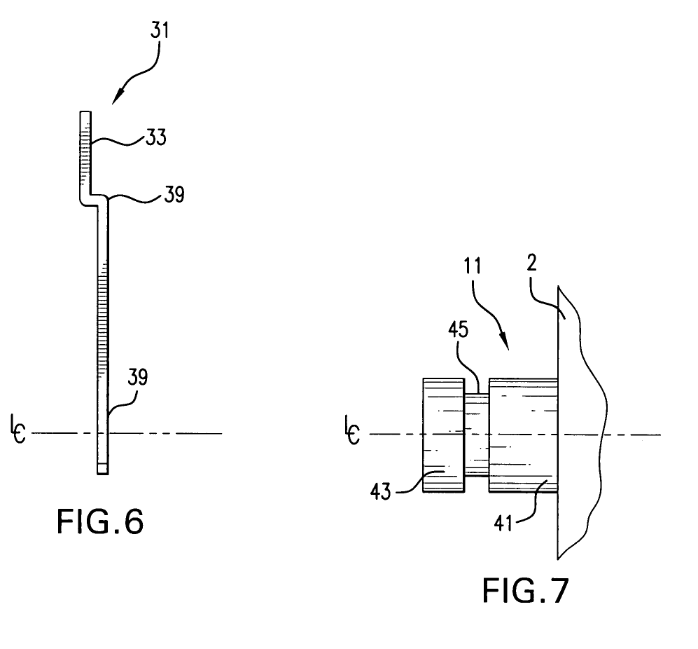

Turning attention to the locking plate 31 of the invention, it is illustrated in front and side elevation in FIGS. 5 and 6 respectively. The locking plate 31 is thin plate of a rigid material. The upper portion of the locking plate 31 provides a finger gripping surface 33. The lower portion of the locking plate 31 is fashioned into a yoke 39 defined by side walls 37-37. Detents 40-40 are mounted in facing relationship to each other on the inside edges of legs 37-37. Near the upper end of the locking plate 31 the locking plate 31 is bent in a tight “S” to form a small shoulder 39.

FIG. 7 illustrates a male fixture 11 comprising a cylindrical body portion 41, a circumferential groove 45 which, by definition, must have a lesser diameter than the body portion 41. The circumferential groove 45 is located between the body portion 41 of the male fixture 11 and the distal end of the male fixture 11 which terminates in a button 43. The button 43 is of a larger diameter than the groove 45 and conveniently may be of the same diameter as the body portion 41. As here shown, the male fixture 11 is fixedly positioned normal to the back 2 of the cradle 1 as is shown in FIG. 2.

Collectively, FIGS. 2 through 7 can be considered to be an exploded view of the assembly that includes the male fixture 11, the locking plate 31 and the female fixture 13 vertically aligned with respect to each other along the line of center [symbol] . To make this assembly the button 43 at the distal end of the male fixture 11 is inserted into the open end of cut out 20 of the female fixture 13 and advanced, as shown in the drawings, in a downwardly direction until it seats in the arcuate bottom of the cut out 21. This can be done without interference provided the locking plate 31 is in a raised position, that is with the shoulder 39 of the locking plate 31 engaged with the lower side of the detent 23 in the back panel 23 of the female fixture 13. When the male fixture 41 is inserted into the female fixture 13 the locking plate 31 is lowered which cause the yoke 39 to seat in the circumferential groove 45 of the male fixture 41. The legs 37-37 (bifurcations) of the locking plate 31 will yield sufficiently to allow the legs 37-37 to pass over the outer diameter of the groove 45. This will secure the male fixture 11 from axial movement. The process can be reversed by retracting the locking plate 31, pulling the detents 37-37 over the diameter of the groove and freeing the male fixture 11 for axial movement away from and out of engagement with the female fixture 13.

From the foregoing description of the drawings it can be understood that the female fixture 13 can be rotated about the male fixture 11 when they are engaged with each other. This provides convenience to a user who can rotate the cradle into a position that is comfortable and convenient. It can be understood that the position of the female fixture 13 should be capable of changing when one sits or stands.

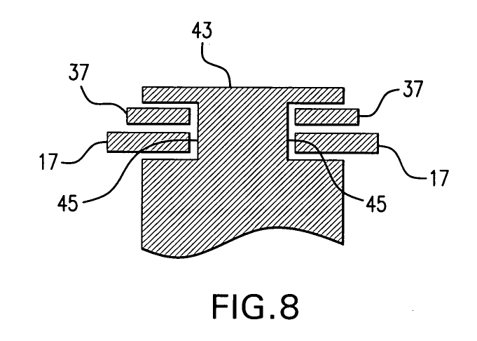

Referring to FIG. 8, it can be seen that the axial width of the groove 45 is occupied by a portion of the side walls 17-17 of the female fixture 13 and the legs 37-37 that define the yoke 39 of the locking plate 31. To reduce the likelihood of developing shear forces on the button 43, it is a good practice to dimension the combined width of the front panel 17 of the female fixture 13 with the width of the legs 37-37 of the locking plate 31 to insure they fit snugly within the groove 45.

The above description may give rise to certain obvious adaptations that are intended to be included within the scope of the invention. For example, in the above description, the female fixture is described as being attached to a person's belt and the male fixture attached to a cradle. It is at once obvious that this orientation of the fixtures can be reversed without any sacrifice of the functionality of the claimed device.

1. A carrying assembly including a first fixture that is adapted to be mounted on an article, a second fixture that is adapted to retain a utilitarian device and means to detachably secure the first and the second fixture one with another, the detachable means comprising a female component of the first fixture functionally related to receive a male component of the second fixture and a locking plate that can be reciprocated from a first position to secure the male component within the female component to a second position that permits the male component to be withdrawn from the female member.

2. A carrying assembly according to claim 1 wherein the first fixture has a back plate joined at its lower end with a substantially parallel spaced apart face plate defining an open space between the back plate and the face plate.

3. A carrying assembly according to claim 2 wherein the face plate has a cutout portion extending from the upper end of the face plate toward the lower end of the face plate with the cutout portion being wider at the upper end of the face plate than it is at a lower end of the face plate.

4. A carrying assembly according to claim 1 wherein the second fixture is attached on one of its sides to the utilitarian device and the male member is mounted on an opposite side.

5. A carrying assembly according to claim 4 wherein the male member is a rod that projects from the opposite side of the second fixture.

6. A carrying assembly according to claim 5 wherein the rod has a circumferential groove positioned near the distal end of the rod.

7. A carrying assembly according to claim 6 wherein the width of the groove exceeds the thickness of the face plate.

8. A carrying assembly according to claim 7 wherein the diameter of the groove is less than width of the cut out potion at the upper end of the face plate and is less than the width of the cut out portion near the lower end of the face plate.

9. A carrying assembly according to claim 1 wherein the locking plate is adapted for sliding movement within the first fixture.

10. A carrying assembly according to claim 9 wherein the locking plate has a bifurcated forked portion at its lower end that is at least as wide as the circumferential groove at the distal end of the rod but narrower than the outside dimension of the rod whereby the male member may be secured within the female member by sliding the bifurcation of the sliding plate into the groove in the male member.

11. A carrying assembly according to claim 1 wherein the utilitarian device is a cellular telephone.

12. A method of detachably joining a first fixture having a female member with a second fixture having a male member in which the female member of the first fixture is adapted to receive the male member of the second fixture, the female member being defined by spaced apart walls in which one of the walls has an opening to into which the male member may be inserted and a bifurcated plate mounted for reciprocation within the female member to engage the male member and secure the male member within the female member.
